(19) United States
(12) Patent Application Publication
(10) Pub. No.: US 2011/0246944 A1
(43) Pub. Date: Oct. 6, 2011

(54) APPLICATION-INDEPENDENT TEXT ENTRY

(75) Inventors: William J. Byrne, Davis, CA (US); Brett Rolston Lider, San Francisco, CA (US); Nicholas Jitkoff, Palo Alto, CA (US); Alexander H. Gruenstein, Mountain View, CA (US); Benedict Davies, London (GB)

(73) Assignee: Google Inc., Mountain View, CA (US)

(21) Appl. No.: 12/754,883

(22) Filed: Apr. 6, 2010

(51) Int. Cl. G06F 3/048

(52) U.S. Cl. 715/835

(57) ABSTRACT

A text processing module can allow a user to compose text prior to selecting another application with which to use or communicate the text. A device can include the text processing module, which receives text input from a user via text input means. The device can display the text in a user interface, along with one or more icons associated with software applications with which the text can be used or communicated. After the user has entered text, the user can activate a displayed icon to select the applications. The text processing module receives the selection and interacts with the selected application to display the text in the selected application and/or communicate the text to another person using the selected application. The text processing module can interact with user contacts to identify possible recipients for the text based on information in the text.

### TECHNICAL FIELD

The present disclosure relates generally to methods and systems for application-independent text entry and, more specifically, to methods and systems that allow a user to compose text prior to selecting an application with which to use or communicate the text.

### BACKGROUND

Electronic devices, such as mobile phones and personal computers, typically have many software applications in which users can compose text. For example, many mobile phones are equipped with a text messaging application, an e-mail application, an Internet web browser application, a word processor application, and a calendar application. Personal computers commonly have many more text-based applications.

Especially for messaging applications on mobile devices, conventional text entry is application-oriented. That is, users are forced to target a particular application before composing a message or other form of text. For example, if a user wants to send a message to another person, the user has to select the application for sending the message prior to composing the message. This requires a user to (a) use multiple different user interfaces for the same or similar activities, (b) save messages and text in different places, and (c) cut and paste the text for use in different applications. Additionally, text that is composed in one application may not be readily accessible for use in another application. For example, if a user composes text in a text messaging application, that text may not be readily accessible to send to another recipient via e-mail. Thus, the user may have to re-compose the same text multiple times to use the text in multiple applications.

Therefore, a need exists in the art for an improved means for text entry.

### SUMMARY

In one exemplary embodiment, a method for application-independent text entry includes receiving input including text provided by a person via at least one input means of a computing device. A user interface on the device displays the text, as well as icons that are each associated with a different software application with which the text may be used. A text processor executing on the device detects a selection by the person of one of the applications and causes the selected application to communicate the text to another person or display the text in the selected application.

In another exemplary embodiment, a system for application-independent text entry includes at least one text input means and a user interface that displays (a) text that has been entered by a person via at least one input means, and (b) icons, each icon associated with a different software application with which the text may be used. The system also includes a text processing module communicably coupled to the user interface. The text processing module detects a selection by the person of one of the software applications and causes the selected application to communicate the text to another person or display the text in the selected application.

In yet another exemplary embodiment, a computer program product has a computer-readable storage medium having computer-readable program code embodied thereon for application-independent text entry. The computer program product includes computer-readable program code for receiving input including text provided by a person via at least one input means; computer-readable program code for displaying a user interface including the text and icons, each icon associated with a different software application with which the text may be used; computer-readable program code for detecting a selection by the person of one of the applications; and computer-readable program code for causing the selected application to communicate the text to another person or display the text in the selected application.

These and other aspects, features and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

FIG. 1 is a block diagram depicting a system for application-independent text entry, in accordance with certain exemplary embodiments.

FIG. 2 is a flow chart depicting a method for application-independent text entry, in accordance with certain exemplary embodiments.

FIG. 3 is a flow chart depicting a method for identifying a recipient from text input, in accordance with certain exemplary embodiments.

FIG. 4 is a flow chart depicting a method for identifying a recipient for text input, in accordance with certain exemplary embodiments.

FIG. 5 is a block diagram depicting a screen image of the graphical user interface of FIG. 1, in accordance with certain exemplary embodiments.

FIG. 6 is a block diagram depicting a screen image of the graphical user interface of FIG. 1, in accordance with certain exemplary embodiments.

FIG. 7 is a block diagram depicting a screen image of the graphical user interface of FIG. 1, in accordance with certain exemplary embodiments.

FIG. 8 is a block diagram depicting a screen image of the graphical user interface of FIG. 1, in accordance with certain exemplary embodiments.

FIG. 9 is a block diagram depicting a screen image of the graphical user interface of FIG. 1, in accordance with certain exemplary embodiments.

FIG. 10 is a block diagram depicting a screen image of the graphical user interface of FIG. 1, in accordance with certain exemplary embodiments.

FIG. 11 is a block diagram depicting a screen image of the graphical user interface of FIG. 1, in accordance with certain exemplary embodiments.

FIG. 12 is a block diagram depicting a screen image of the graphical user interface of FIG. 1, in accordance with certain exemplary embodiments.

FIG. 13 is a block diagram depicting a screen image of the graphical user interface of FIG. 1, in accordance with certain exemplary embodiments.

### DETAILED DESCRIPTION OF EXEMPLARY EMBODIMENTS

### Overview

A method and system for application-independent text entry allows a user to compose text prior to selecting an application with which to use or communicate the text. A user can choose to enter a note, message, reminder, appointment, or other type of text into a mobile phone or other device by speech or typing. If the text is entered by speech, a speech recognition module can convert the speech into text in real-time and the device can display the text to the user.

After the user has composed text, the user can select one or more applications with which to use or communicate the text. For example, the user can enter text and then decide whether the text should be sent as a text message, e-mail, or an update to a social networking site status. In another example, the user can compose text and then apply the text to a non-messaging application, such as a calendar or word processor application. Thus, the user can enter text and decide later what to do with the text.

### System Architecture

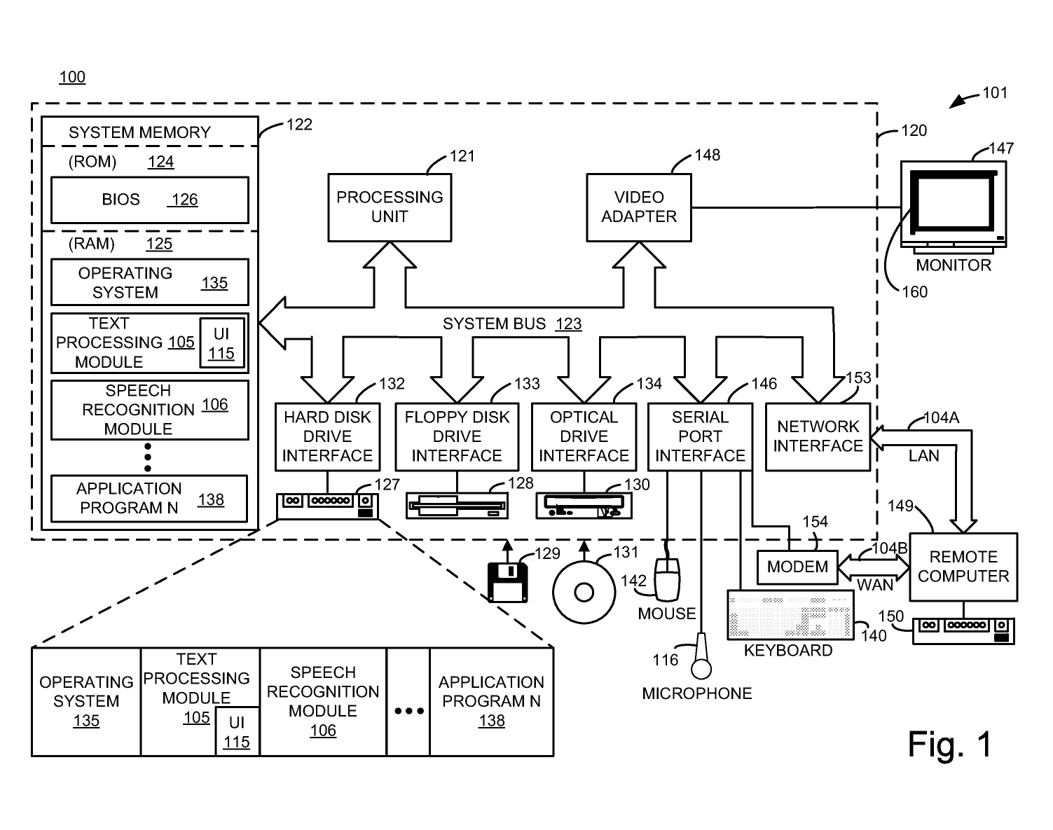

Turning now to the drawings, in which like numerals indicate like elements throughout the figures, exemplary embodiments are described in detail. FIG. 1 is a block diagram depicting a system 100 for application-independent text entry, in accordance with certain exemplary embodiments. The system 100 is implemented in a computing device 101, such as a mobile phone, personal digital assistant (“PDA”), laptop computer, desktop computer, handheld computer, or any other wired or wireless processor-driven device. For simplicity, the exemplary device 101 is described herein as a personal computer 120. A person of ordinary skill in the art having the benefit of the present disclosure will recognize that certain components of the device 101 may be added, deleted, or modified in certain alternative embodiments. For example, a mobile phone or handheld computer may not include all of the components depicted in the computer 102 illustrated in FIG. 1 and/or described below.

Generally, the computer 120 includes a processing unit 121, a system memory 122, and a system bus 123 that couples various system components, including the system memory 122, to the processing unit 121. The system bus 123 can include any of several types of bus structures, including a memory bus or memory controller, a peripheral bus, or a local bus, using any of a variety of bus architectures. The system memory 122 includes a read-only memory (“ROM”) 124 and a random access memory (“RAM”) 125. A basic input/output system (BIOS) 126 containing the basic routines that help to transfer information between elements within the computer 120, such as during start-up, is stored in the ROM 124.

The computer 120 also includes a hard disk drive 127 for reading from and writing to a hard disk (not shown), a magnetic disk drive 128 for reading from or writing to a removable magnetic disk 129 such as a floppy disk, and an optical disk drive 130 for reading from or writing to a removable optical disk 131 such as a CD-ROM, compact disk—read/write (CD/RW), DVD, or other optical media. The hard disk drive 127, magnetic disk drive 128, and optical disk drive 130 are connected to the system bus 123 by a hard disk drive interface 132, a magnetic disk drive interface 133, and an optical disk drive interface 134, respectively. Although the exemplary device 101 employs a ROM 124, a RAM 125, a hard disk drive 127, a removable magnetic disk 129, and a removable optical disk 131, it should be appreciated by a person of ordinary skill in the art having the benefit of the present disclosure that other types of computer readable media also can be used in the exemplary device 101. For example, the computer readable media can include any apparatus that can contain, store, communicate, propagate, or transport data for use by or in connection with one or more components of the computer 120, including any electronic, magnetic, optical, electromagnetic, infrared, or semiconductor system (or apparatus or device) or propagation medium, such as magnetic cassettes, flash memory cards, digital video disks, Bernoulli cartridges, and the like. The drives and their associated computer readable media can provide nonvolatile storage of computer-executable instructions, data structures, program modules, and other data for the computer 120.

A number of modules can be stored on the ROM 124, RAM 125, hard disk drive 127, magnetic disk 129, or optical disk 131, including an operating system 135 and various application modules 105, 106, and 138. Application modules 105, 106, and 138 can include routines, sub-routines, programs, objects, components, data structures, etc., which perform particular tasks or implement particular abstract data types. Application module 105, referred to herein as a “text processing module” 105, and application module 106, referred to herein as a “speech recognition module” 106 are discussed in more detail below. The application module 138 can include a targeted messaging application, such as an e-mail or text messaging application, for sending messages to another person. The application module 138 also can include a non-targeted application, such as an Internet web browser, word processor, or calendar application.

A user can enter commands and information to the computer 120 through one or more input devices, such as a keyboard 140 and a pointing device 142. The pointing device 142 can include a mouse, a trackball, an electronic pen that can be used in conjunction with an electronic tablet, or any other input device known to a person of ordinary skill in the art, such as a joystick, game pad, satellite dish, scanner, or the like. In certain exemplary embodiments, the input devices can include a touch sensitive screen 160. For example, the touch screen 160 can include resistive, capacitive, surface acoustic wave (“SAW”), infrared (“IR”), strain gauge, dispersive signal technology, acoustic pulse recognition, and/or optical touch sensing technology, as would be readily understood by a person of ordinary skill in the art having the benefit of the present disclosure.

The input devices can be connected to the processing unit 122 through a serial port interface 146 that is coupled to the system bus 123 or one or more other interfaces, such as a parallel port, game port, a universal serial bus (“USB”), or the like. A display device 147, such as a monitor, also can be connected to the system bus 123 via an interface, such as a video adapter 148. In certain exemplary embodiments, the display device 147 can incorporate the touch screen 160, which can be coupled to the processing unit 121 through an interface (not shown). In addition to the display device 147, the computer 120 can include other peripheral output devices, such as speakers (not shown) and a printer (not shown).

The device 101 can receive text input from a user via the keyboard 140 or a microphone 116. The keyboard 140 can be a physical keyboard stored on or coupled to the device 101 or a virtual keyboard displayed on or through the touch screen 160. The microphone 140 is logically coupled to the speech recognition module 137 for receiving speech input from a user and converting the speech input into text.

The computer 120 is configured to operate in a networked environment using logical connections to one or more remote computers 149 or other network devices. Each remote computer 149 can include a network device, such as a personal computer, a server, a client, a router, a network PC, a peer device, or other device. While the remote computer 149 typically includes many or all of the elements described above relative to the computer 120, only a memory storage device 150 has been illustrated in FIG. 1 for simplicity. The logical connections depicted in FIG. 1 include a LAN 104A and a WAN 104B. Such networking environments are commonplace in offices, enterprise-wide computer networks, intranets, and the Internet.

When used in a LAN networking environment, the computer 120 is often connected to the LAN 104A through a network interface or adapter 153. When used in a WAN networking environment, the computer 120 typically includes a modem 154 or other means for establishing communications over the WAN 104B, such as the Internet. The modem 154, which can be internal or external, is connected to the system bus 123 via the serial port interface 146. In a networked environment, program modules depicted relative to computer 120, or portions thereof, can be stored in the remote memory storage device 150.

It will be appreciated that the network connections shown are exemplary and other means of establishing a communications link between the computers can be used. Moreover, those skilled in the art will appreciate that the device 101 illustrated in FIG. 1 can have any of several other suitable computer system configurations.

The text processing module 105 includes software for receiving text input from a user via the keyboard 140 or the microphone 116 and speech recognition module 106 and applying the text to another software application selected by the user. The text processing module 105 provides a graphical user interface 115 via the display 147 to present the received text input to the user. The user interface 115 may display the text in real-time or near real-time as the text is received from the user. The user interface 115 also displays one or more icons or other selectable items that are each associated with a software application that the user can select for using in connection with the text.

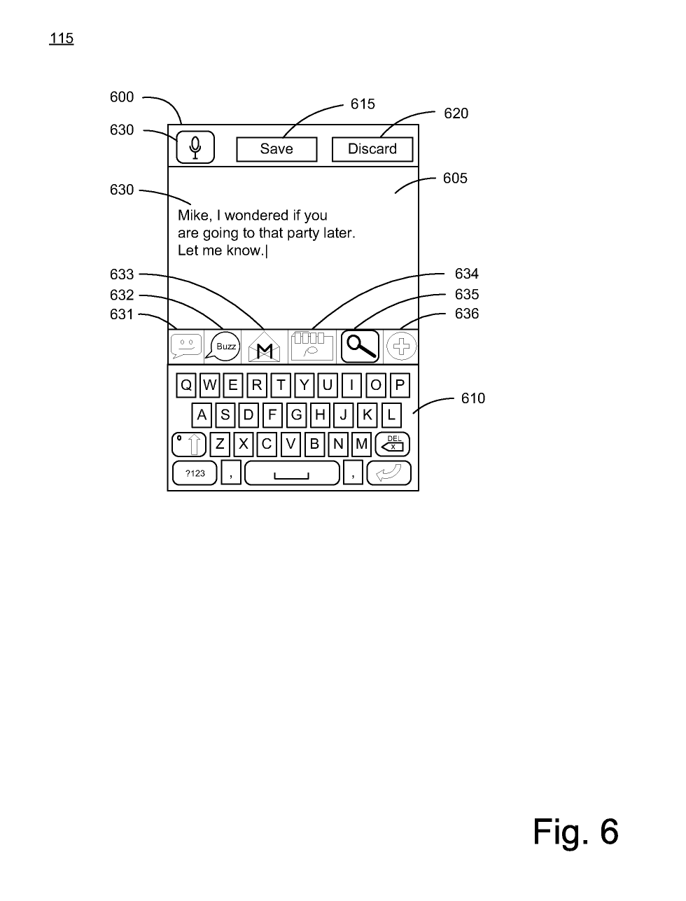

FIG. 6 is a block diagram depicting the user interface 115, in accordance with certain exemplary embodiments. With reference to FIGS. 1 and 6, an exemplary screen image 600 of the user interface 115 displays the text 650 and selectable icons 631-636 for software applications with which the text 650 may be used. Icon 631 corresponds to a text messaging application; icon 632 corresponds to an instant messaging application; icon 633 corresponds to an e-mail application; icon 634 corresponds to a calendar application; and icon 635 corresponds to a search application.

The text processing module 105 can store received text 650 in the RAM 125, the hard disk drive 127, the magnetic disk 129, and/or the optical disk 131. In certain exemplary embodiments, the device 101 may include a text-based document file or database stored in one of the aforementioned memory locations. The text processing module 105 can automatically store input text 650 as the text 650 is received from the user. In addition, or in the alternative, the user interface 115 may include a “Save” icon 615 the user may select to save the text 650. The user interface 115 also may include a “Discard” icon 620 for deleting the text 650 from the user interface 115 and/or from the device 101.

The text processing module 105 interacts with a software application selected by the user to use the text 650 in or with the selected application 138. For example, if the user selects a text messaging application to transmit the text 650 to another person, the text processing module 105 can make a call to the text messaging application, transmit the text 650 to the text messaging application, and send a command to the text messaging application to send the text 650 to the other person. The messaging application can then send the text 650 to the other person without any further involvement of the user.

In another example, if the selected software application is a non-targeted application, such as a calendar application, the text processing module 105 can make a call to the non-targeted application and send the text 650 to the non-targeted application. The non-targeted application may then open and display the text 650. With the non-targeted application open, the user can save or perform other operations in connection with the text 650 using the non-targeted application. In yet another example, the user may elect to perform an Internet search using the text 650. In this example, the text processing module 105 can make a call to an Internet web browser application to open an Internet search page, populate a search field of the Internet search page with the text 650, and/or cause the Internet search page to perform a search for the text 650.

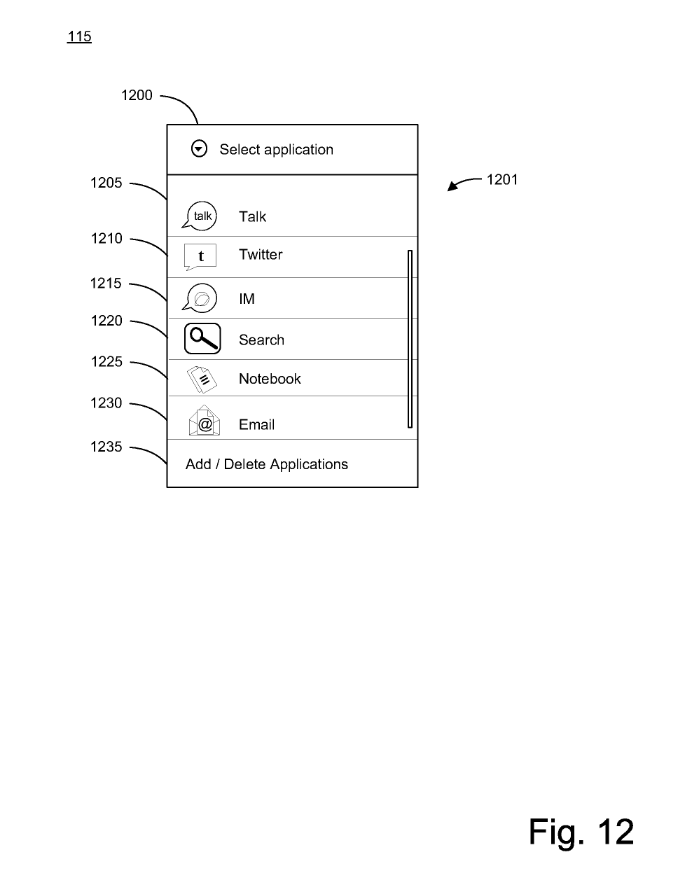

In certain exemplary embodiments, the user can customize the icons 631-636 displayed at the user interface 115. For example, the user interface 115 may initially display icons for each software application stored on or accessible via the device 101, which may use or communicate text 650. Thereafter, the user may add or delete icons 631-636 from the user interface 115. This operation is described in more detail below in connection with FIG. 12.

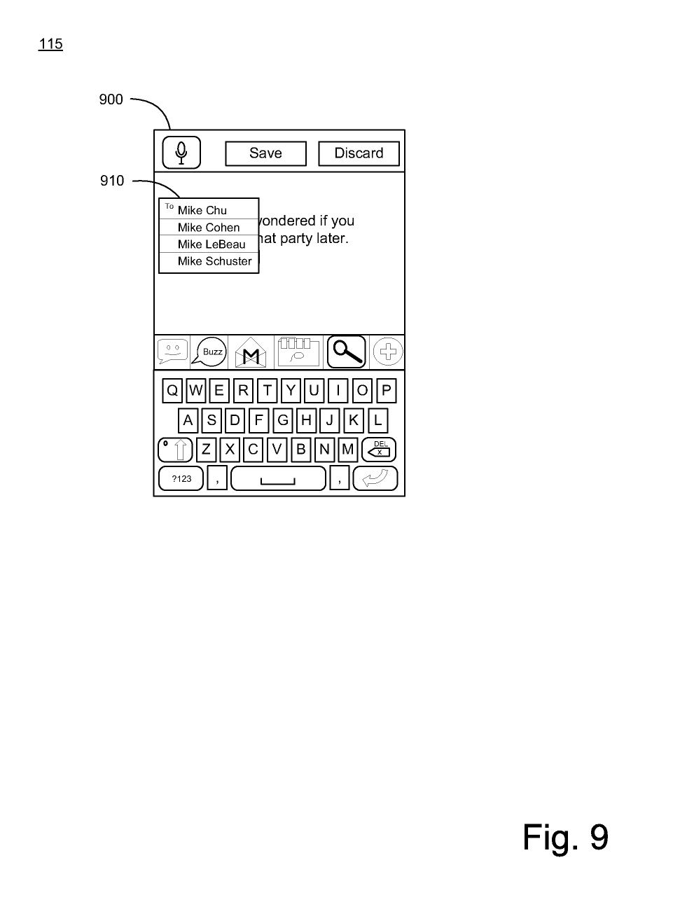

The text processing module 105 also can compare content of the text input to a set of contacts (not shown) of the user to predict whether the text input is intended to be communicated to one of the contacts. The text processing module 105 may interact with multiple sets of contacts, each associated with a different messaging application. For example, the device 101 may include a text messaging application and an e-mail application that each have a set of contacts for the user. In this example, the text processing module 105 may interact with both sets of contacts to predict whether the text input is intended for one of the contacts. If one or more contacts are predicted, the text processing module 105 may present the one or more contacts to the user for selection via the user interface 115. For example, briefly referring to FIG. 9, predicted contacts may be presented to the user in a drop-down menu 910. FIG. 9 is described in more detail below.

### Process

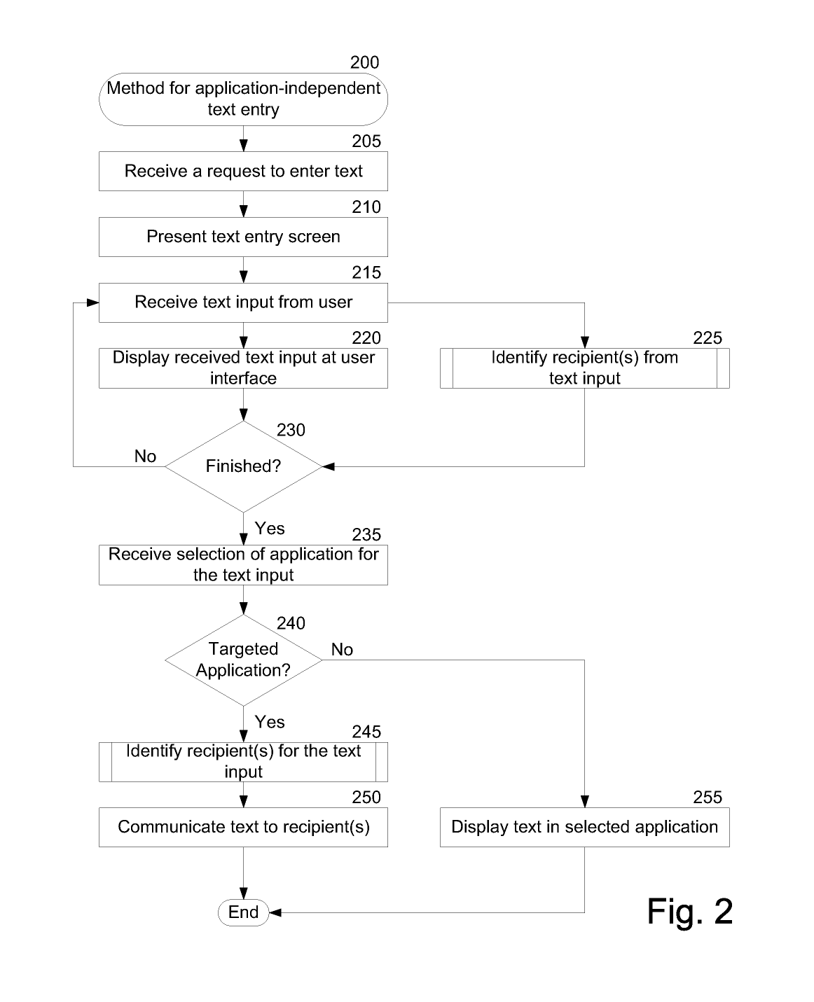

The components of the device 101 are described hereinafter with reference to the exemplary methods illustrated in FIGS. 2-4. The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, a skilled programmer would be able to write such computer programs to implement exemplary embodiments based on the flow charts and associated description in the application text. Therefore, disclosure of a particular set of program code instructions is not considered necessary for an adequate understanding of how to make and use the exemplary embodiments. Further, those skilled in the art will appreciate that one or more steps described may be performed by hardware, software, or a combination thereof, as may be embodied in one or more computing systems.

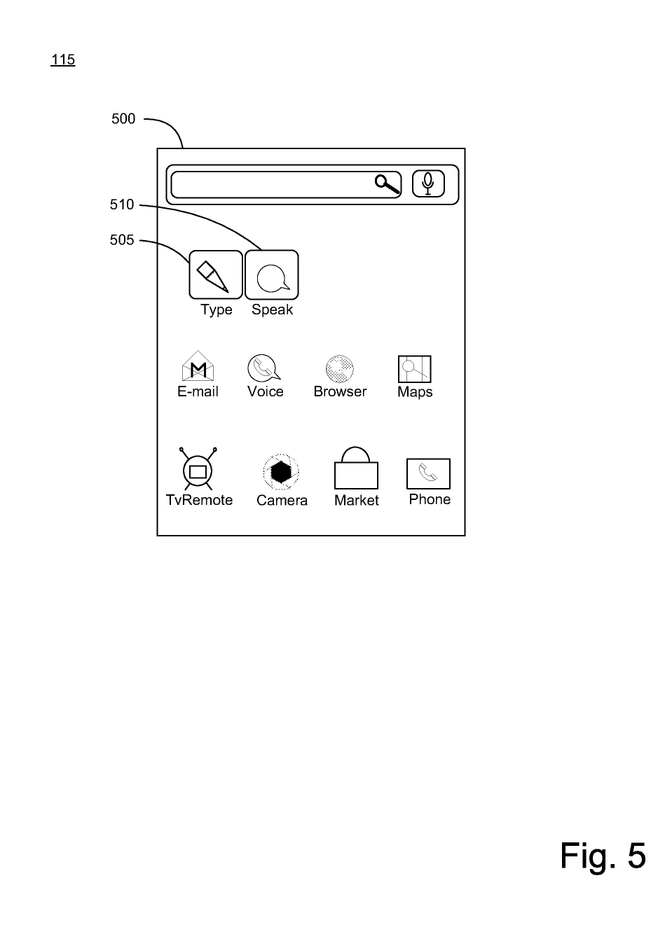

FIG. 2 is a flow chart depicting a method 200 for application-independent text entry, in accordance with certain exemplary embodiments. This method 200 may be implemented using a computer program product having a computer-readable storage medium with computer program instructions embodied therein for performing the steps described below. The method 200 is described hereinafter with reference to FIGS. 1 and 2. Additionally, reference is made to FIGS. 5-13, which are block diagrams depicting exemplary screen images of the graphical user interface 115 of FIG. 1, in accordance with certain exemplary embodiments.

In block 205, the text processing module 105 receives a request from a user to enter text. In certain exemplary embodiments, the text processing module 105 can receive the request via one or more input devices of the device 101. For example, the user can request to enter text by activating an icon displayed on or through the touch screen 160. Referring to FIG. 5, the user may activate a “Type” icon 505 to enter text 650 via a typing means, such as the keyboard 140. Alternatively, the user may activate a “Speak” icon 510 to enter text via a speech recognition input means, such as the microphone 116 and speech recognition module 106. In a touch screen embodiment, the user may activate one of the icons 505 or 510 by touching the touch screen 160 at a location corresponding to the icon 505 or 510, respectively. Alternatively, the user may navigate a cursor to the icon 505 or 510 using the pointing device 142 and then select the icon 505 or 510 using the pointing device 142. In certain exemplary embodiments, the text processing module 105 may be placed into an active listening mode where the text processing module 105 enters into a speech entry mode whenever speech is detected by the microphone 116.

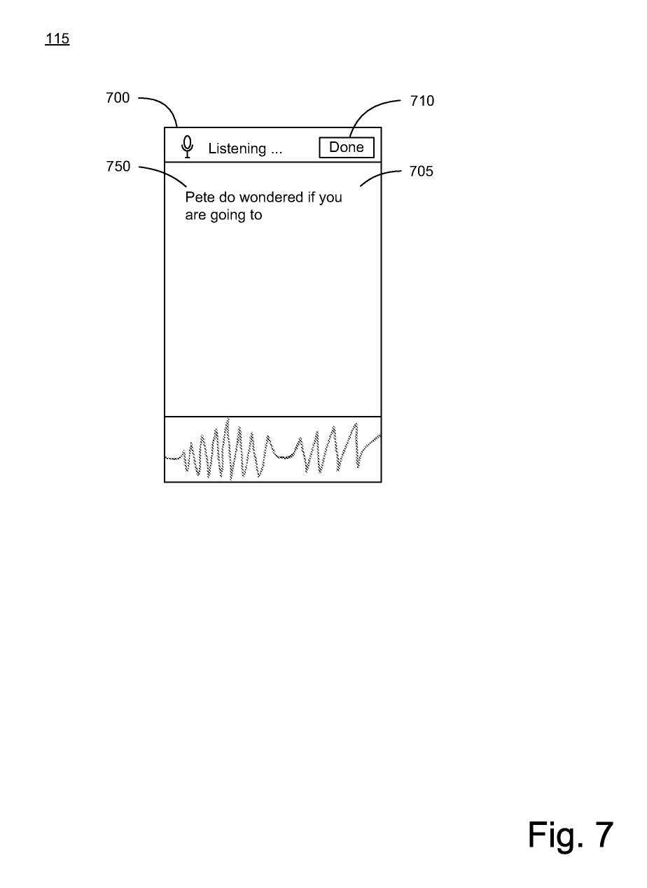

Referring back to FIGS. 1 and 2, in block 210, the user interface 115 presents a text entry screen to the user via the display 147. In certain exemplary embodiments, the user interface 115 may include a different screen for speech-based text entry versus typing-based text entry. For example, the user interface 115 may present a screen similar to that of screen image 600 depicted in FIG. 6 for typing-based text entry, and the user interface 115 may present a screen similar to that of screen image 700 depicted in FIG. 7 for speech-based text entry. Alternatively, the user interface 115 may present the same screen for both typing-based and speech-based text entry. For example, a screen similar to that of screen image 600 of FIG. 6 may be used for both types of text entry.

As shown in FIG. 6, the user interface 115 can provide a screen 600 having a virtual keyboard 610 for receiving text 650 from a user and a text display area 605 for displaying the received text 650 to the user. The user interface 115 also provides a “Save” icon 615 the user can activate to save text 650 in one of the memory storage devices 125, 127, 129, or 131 for later use and a “Discard” icon 620 the user can activate to clear the text 650 from the text display area 605 and/or from the memory storage device 125, 127, 129, or 131. The user interface 115 also can display selectable icons for one or more applications with which the text 650 may be used and/or communicated. In this exemplary screen image 600, the user interface 115 displays an icon 631 for a text messaging application, an icon 632 for an instant messaging application, an icon 633 for an e-mail application, an icon 634 for a calendar application, and an icon 635 for a search application.

In certain exemplary embodiments, the exemplary screen image 600 may include selectable icons 631-635 for only a subset of the applications with which the text can be used and/or communicated. The user interface 115 also includes an expand “+” icon 636 that allows a user to select from additional applications with which input text 650 may be used and/or communicated that may not be displayed on the screen image 600. For example, a screen similar to that of screen image 1200 illustrated in FIG. 12 may be displayed when the expand icon 636 is activated. Referring to FIG. 12, the user interface 115 can display a list 1201 having selectable icons 1205-1230 for each application 1205-1230 with which the text can be used and/or communicated. The user interface 115 also can include a selectable “Add/Delete Applications” icon 1235 the user can select to navigate to a user interface (not shown) for adding applications to or deleting applications from the screen image 600 and/or the list 1201. For example, the user may add an icon to the screen image 600 for an application that the user commonly uses. In another example, a user may delete an icon from the screen image 600 for an application that the user rarely uses.

The user interface 115 also can provide a speech-input icon 630 for navigating to a speech-input screen, such as a screen similar to that of screen image 700 of FIG. 7. Referring to FIG. 7, the user interface 115 includes a text display area 705 for displaying text 750 converted from speech input. This exemplary user interface 115 also includes a “Done” icon 710 that the user can select to indicate that the user has finished entering text 750 via speech input. After the “Done” icon 710 is selected, text processing module 105 can go back to a non-listening mode.

Referring back to FIGS. 1 and 2, in block 215, the text input is received at the text processing module 105. In block 220, the user interface 115 displays the received text input on the display 147. The text can be displayed in a text display area, such at the text display area 605 illustrated in FIG. 6. The user interface 115 allows for the user to make corrections to the text as it is received. For example, if the text input is received via a speech input means, the speech recognition module 106 may misinterpret part of the speech input. If so, the user can select a word or phrase that needs to be corrected and the user interface 115 can highlight that word or phrase. The user can then repeat that word or phrase or type the correct word or phrase using the keypad 135. Additionally, the user interface 115 may provide predicted corrections for a word or phrase that has been selected by the user. The user can select one of the predicted corrections or type in the correct word or phrase.

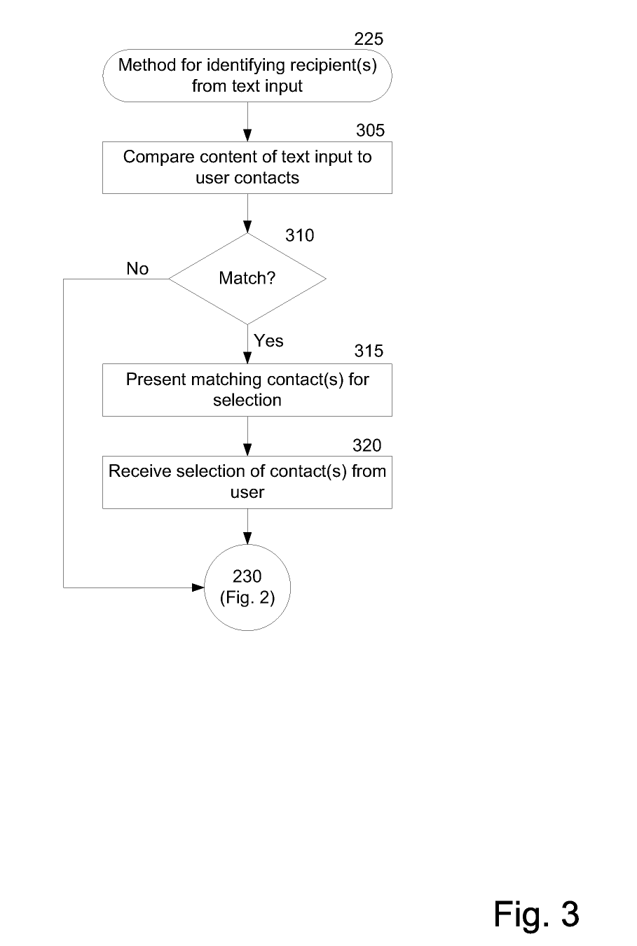

In block 225, the text processing module 105 can identify one or more possible recipients for the text input based on the contents of the text input. As depicted in FIG. 2, the text processing module 105 can perform this process in parallel with the user entering text. Alternatively, the text processing module 105 can perform this process after the user has finished entering text. Block 225 is described in further detail below with reference to FIG. 3.

In block 230, the text processing module 105 determines whether the user has finished entering text. For example, the user interface 115 may include a “Done” icon or button that the user may select to indicate that the text is complete. In another example, the text processing module 105 may determine that the user is finished entering text based on the user selecting an application with which to use or communicate the text 650. In yet another example, the user interface 115 may provide an icon or button for the user to select to close or navigate away from a text entry screen. The text processing module 105 can then determine that the user is finished entering text and also automatically save the text to one of the memory storage devices 125, 127, 129, or 131. If the user is finished entering text, the method 200 proceeds to block 235. Otherwise, the method 200 returns to block 215.

In block 235, the text processing module 105 receives a selection of an application with which to use and/or communicate text input. For example, referring to FIG. 6, the user may select one of the icons 631-635 corresponding to an application. Or, the user may select the expand icon 636 to open a window, such as the screen 1200 illustrated in FIG. 12, to select an application 1205-1230.

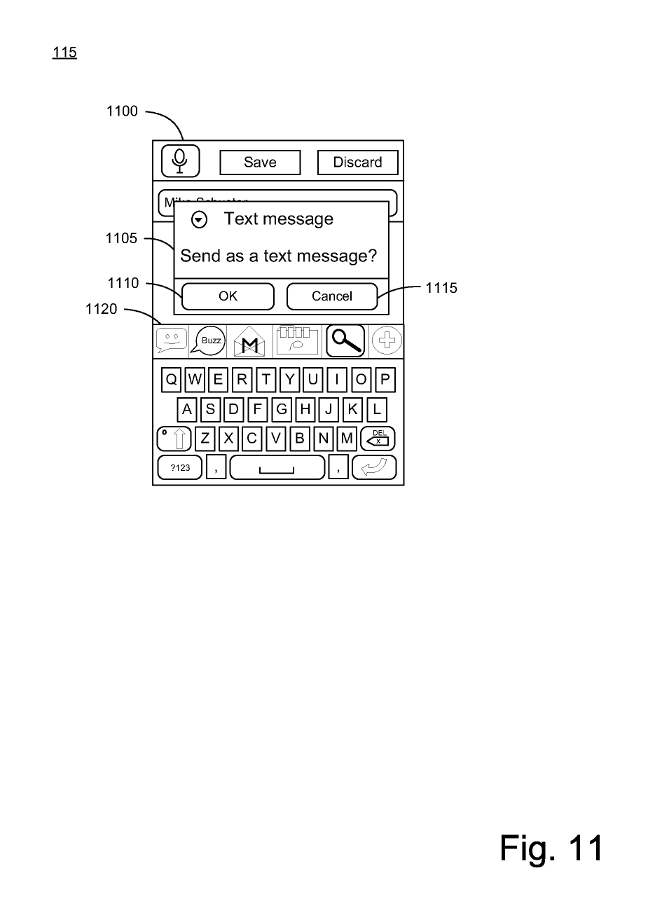

After the text processing module 105 receives the selection of an application, the user interface 115 can provide a confirmation screen to the user to confirm the user selection. For example, FIG. 11 depicts an exemplary confirmation screen 1100 confirming that a user intends to send the text input to another person using a text messaging application. For example, this confirmation screen 1110 may be displayed in response to the user selecting a text messaging icon 1120 corresponding to a text messaging application. At this point, the user could select an “OK” icon 1110 to send the text input as a text message or a “Cancel” icon 1115 to return to a text entry screen without sending the text input as a text message.

In block 240, if the selected application is a targeted messaging application for sending the text input as a message to another person (or the user), the method 200 branches to block 245. If the selected application is not a targeted messaging application, the method branches to block 255.

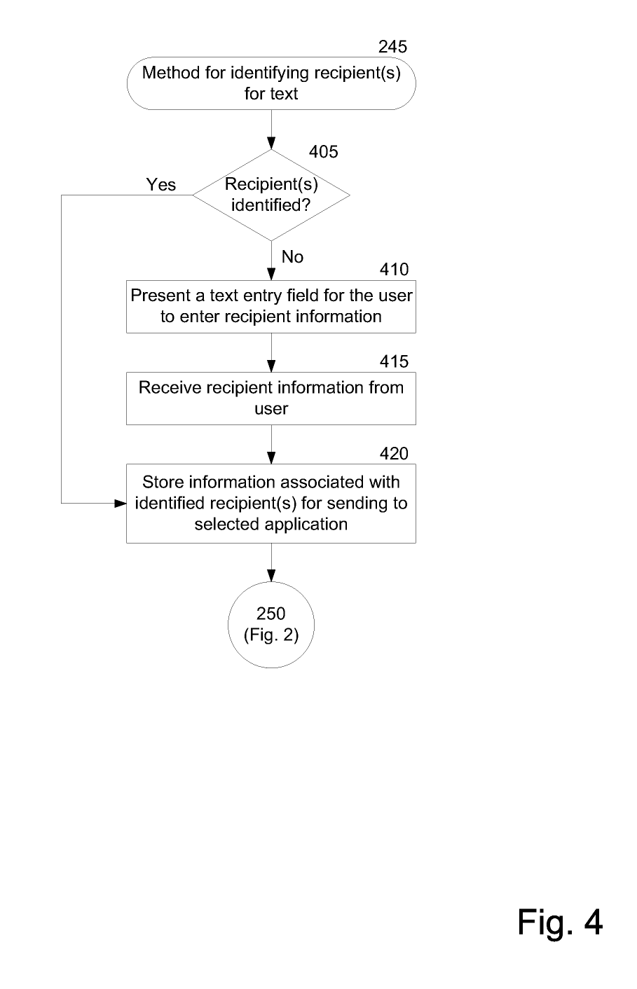

In block 245, the text processing module 105 identifies one or more recipients for the text input. If a recipient was identified in block 225, then the text processing module 105 may use that recipient for the text input. The user interface 115 also may display a text entry field for the user to enter recipient information. In addition, the user interface 115 may display a list of contacts from which the user can select the recipient. For example, the list of recipients may be delivered from contact information associated with the selected application. This block 245 for determining one or more recipients for the text input is described in further detail below with reference to FIG. 4.

In block 250, the text processing module 105 interacts with the selected application to send the text input to the recipient(s) determined in block 245. The text processing module 105 can make a call to activate the selected application and copy and paste the text input into an appropriate field in the selected application. For example, if the selected application is a text messaging application, the text processing module 105 can copy and paste the text input into a message body of a new text message. The text processing module 105 also can transfer information associated with the recipient(s) to the selected application. Continuing the text message example, the text processing module 105 can transfer a mobile phone number associated with the recipient(s) to the text messaging application. After the appropriate information is provided to the selected application, the text processing module 105 can instruct the selected application to send the text input to the recipients(s). The actions completed in block 250 to send the text input to the recipient(s) can be completed automatically without any interaction with the user.

In block 255, the text processing module 105 interacts with the selected application to display the text input in the selected application. The text processing module 105 can make a call to activate the selected application and to display a user interface for the application in the display 110. The text processing module 105 also can copy and paste the text into the user interface for the application. For example, if the selected application is a word processor, the text processing module 105 can open the word processor and the text input into a new document in the word processor. In another example, if the user selects to perform an Internet search using the text input, the text processing module 105 can open an Internet web browser application to an Internet search website, copy the text input into a search query field, and request that the website perform a search using the text input.

After blocks 250 and 255, the method 200 ends. However, the text input composed by the user may still be displayed in the user interface 115. Thus, the user may select another application to use the same text input. For example, after the user sends a message to a person using a text messaging application, the user may send the same text to another user via an e-mail application.

Additionally, the user can manually save the text input or the text processing module 105 can automatically save the text input in one of the memory storage devices 125, 127, 129, or 131. The user can then retrieve the saved text input from memory storage device 125, 127, 129, or 131 at a later time and choose an application with which to use and/or communicate the text.

FIG. 3 is a flow chart depicting a method 225 for identifying a recipient from text input, in accordance with certain exemplary embodiments, as referenced in block 225 of FIG. 2. The method 225 is described below with reference to FIGS. 1-3.

In block 305, the text processing module 105 compares at least a portion of the content of the text input received from the user to one or more sets of contacts. In certain exemplary embodiments, the text processing module 105 may compare each word in the text input to each contact for each application with which the text processing module 105 can interact with. For example, if the text processing module 105 is configured to interact with a text messaging application and an e-mail application, the text processing module 105 may compare each word in the text input to each of the user's contacts for the text messaging application and to each of the user's contacts for the e-mail application to determine if one of the words matches one of the contacts.

In certain exemplary embodiments, the text processing module 105 may scan the contents of the text input to detect any names or titles in the text input. If a name or title is detected, the text processing module 105 may compare the identified name or title to a set of contacts to determine whether the name or title matches one of the contacts. For example, in the exemplary screen image 600 of FIG. 6, the text display area 605 displays the text 650, “Mike, I wondered if you are going to that party later. Let me know.” In this example, the text processing module 105 may detect the name “Mike” in the text 650 and compare the name “Mike” to each of the user's contacts.

If a match is found, the method 225 proceeds to block 310. Otherwise, the method 225 proceeds to block 230, which is described above.

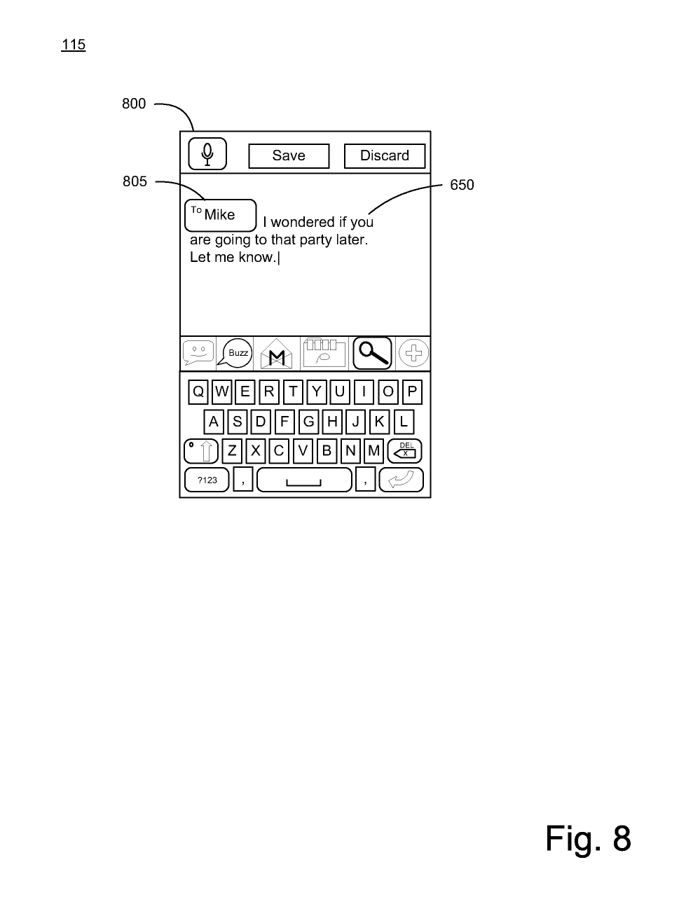

In block 315, the user interface 115 displays the matching contact(s) to the user for selection. For example, referring to exemplary screen image 800 of FIG. 8, the user interface 115 may highlight a name 805 in the text 650 that matches one or more contacts. If the user selects the highlighted name 805, a list of contacts matching that name may be displayed. For example, referring to exemplary screen image 900 of FIG. 9, a list of contacts 910 having the name “Mike” may be displayed by the user interface 115 in response to the name “Mike” being detected in the text input.

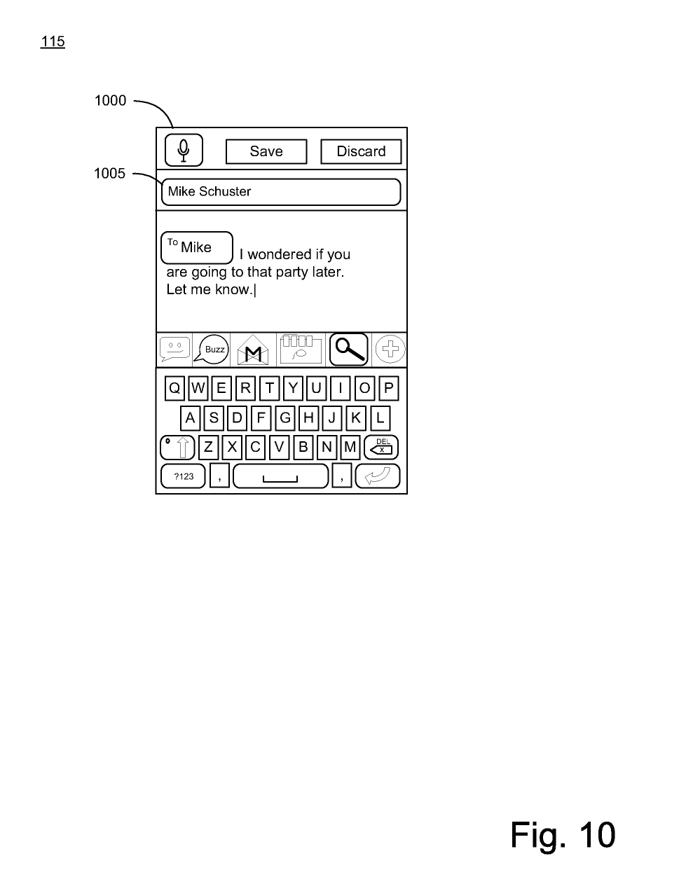

In block 320, the user can select one or more of the contacts to receive the text input. The text processing module 105 can receive the selection via the user interface 115 and store the selection in one of the memory storage devices 125, 127, 129, or 131 until the text is ready to be sent to the selected contact(s). The user interface 115 also may display the selected contact(s) to the user. For example, FIG. 10 depicts an exemplary screen image 1000 where contact “Mike Schuster” 1005 was selected as a recipient from the list of contacts 910 of FIG. 9.

FIG. 4 is a flow chart depicting a method 245 for identifying a recipient for text input, in accordance with certain exemplary embodiments, as referenced in block 225 of FIG. 2. The method 245 is described below with reference to FIGS. 1-4.

In block 405, the text processing module 105 determines whether a recipient was identified in block 225. If a recipient was not identified in block 225, the method 405 proceeds to block 410 so that one or more recipients can be selected. If one or more recipients were previously identified in block 225, the method 405 can proceed to block 420 to use those recipients for the text input. Alternatively, the method 245 may proceed to block 410 even if a recipient was previously identified so that the user may specify additional recipients.

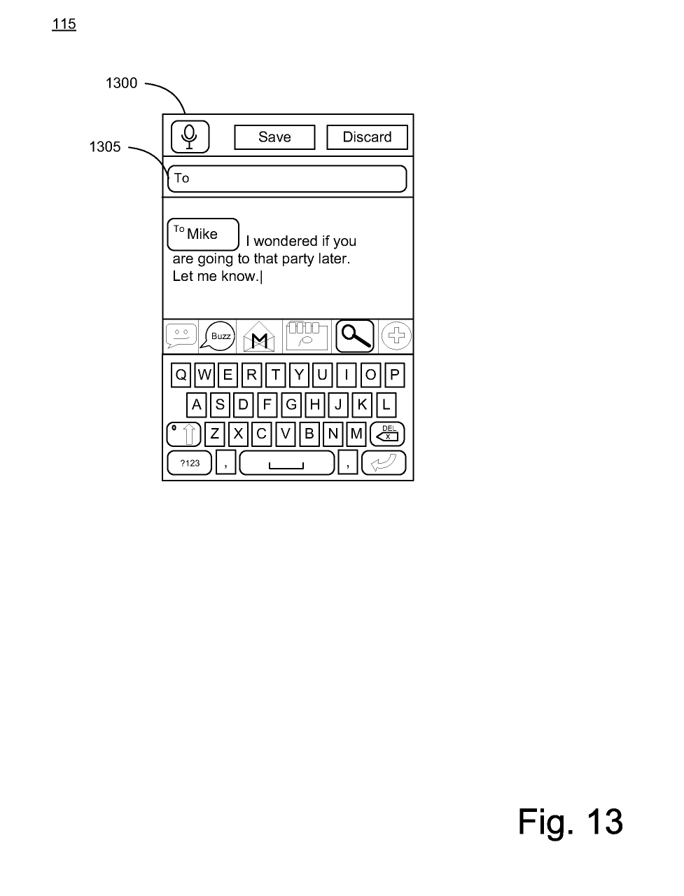

In block 410, the user interface 115 presents a text entry field for the user to specify one or more recipients for the text input by entering information associated with the one or more recipients. For example, if the selected application is an e-mail application, the user may enter an e-mail address for each of the one or more recipients. In another example, if the selected application is a text messaging application, the user may enter a phone number associated with a mobile phone of each recipient. In yet another example, the user interface 115 may include a contact sensing feature where the user can enter the name of a contact and the user interface can identify the appropriate contact information for the entered contact. FIG. 13 depicts an exemplary screen image 1300 having a text entry field for the user to specify one or more recipients. In addition to the text entry field, the user interface 115 may present a list of contacts 125 associated with the selected application from which the user may select one or more recipients.

In block 415, the text processing module 105 receives recipient information and/or the selection of a contact for each of recipient from the user interface 115. In block 420, the text processing module 105 stores information associated with the recipients in memory, (e.g., RAM 125). That information may be sent to the selected application for use in communicating the text 650.

### General

The exemplary methods and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are included in the inventions described herein.

The exemplary embodiments can be used with computer hardware and software that performs the methods and processing functions described above. As will be appreciated by those skilled in that art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer program product for application-independent text entry, the computer program product comprising:
a computer-readable storage medium having computer readable program code embodied thereon, the computer-readable program code comprising:
computer-readable program code for receiving input comprising text provided by a person via at least one input means;
computer-readable program code for displaying a user interface comprising the text and a plurality of icons, each icon associated with a different software application with which the text may be used;
computer-readable program code for detecting a selection by the person of one of the applications; and
computer-readable program code for causing the selected application to do one of: (1) communicate the text to another person, and (2) display the text in the selected application.

2. The computer program product of claim 1, wherein the selected application comprises one of an e-mail application, a text messaging application, a social networking Internet website, a search application, a word processor, and a calendar application.

3. The computer program product of claim 1, wherein the at least one input means comprises at least one of a speech recognition means and a typing means.

4. The computer program product of claim 3, wherein the speech recognition means converts the text input into text and wherein the converted text is displayed by the user interface substantially in real-time.

5. The computer program product of claim 1, wherein the computer-readable program code further comprises computer-readable program code for receiving, from the person, a selection of an additional software application for which to display an icon on the user interface.

6. The computer program product of claim 1, wherein the computer-readable program code for causing the selected application to communicate the text to another person comprises:
computer-readable program code for making a call to the selected application;
computer-readable program code for transmitting the text to the selected application;
computer-readable program code for identifying at least one recipient for the text to the selected application; and
computer-readable program code for instructing the selected application to communicate the text to the recipient.

7. The computer program product of claim 1, further comprising:
computer-readable program code for determining whether the text comprises information identifying a recipient of the text;
computer-readable program code for, in response to determining that the text comprises information identifying the recipient, determining whether the information is associated with at least one contact of the person;
computer-readable program code for, in response to determining that the information is associated with at least one contact, presenting a selectable list comprising information identifying each contact; and
computer-readable program code for receiving a selection of at least one identified contact,
wherein the computer-readable program code for causing the selected application to communicate the text to another person causes the selected application to communicate the text to each selected contact.

8. The computer program product of claim 1, wherein the computer program code for displaying the text in the selected application comprises:
computer-readable program code for making a call to the selected application;
computer-readable program code for transmitting the text to the selected application; and
computer-readable program code for instructing the selected application to display the text.

9. The computer program product of claim 1, further comprising computer-readable program code for automatically storing the received input in memory.

10. A system for application-independent text entry, comprising:
at least one text input means;
a user interface provided that displays (a) text that has been entered by a person via the at least one input means, and (b) a plurality of icons, each icon associated with a software application with which the text may be used; and
a text processing module communicatively coupled to the user interface, the text processing module detecting a selection by the person of one of the software applications,
and causing the selected application to do one of: (i) communicate the text to another person, and (ii) display the text in the selected application.

11. The system of claim 10, wherein the selected application comprises one of an e-mail application, a text messaging application, a social networking Internet website, a search application, a word processor, and a calendar application.

12. The system of claim 10, wherein the at least one text input means comprises at least one of a speech recognition means and a typing means.

13. The system, of claim 12, wherein the speech recognition means converts the text input into text and wherein the converted text is displayed by the user interface substantially in real-time.

14. The system of claim 10, wherein the user interface comprises an administrative user interface for receiving, from the person, a selection of an additional software application for which to display an icon on the user interface.

15. The system of claim 10, wherein the text processing module communicates the text to another person by:
making a call to the selected application;
transmitting the text to the selected application;
identifying at least one recipient for the text to the selected application; and
instructing the selected application to communicate the text to the recipient.

16. The system of claim 10, wherein the text processing module identifies a recipient for the text prior to communicating the text to another person by comparing at least a portion of the text to information associated with a plurality of contacts of the person and presenting any contacts that match the portion of text to the person via the user interface.

17. The system of claim 10, wherein the text processing module displays the text in the selected application by:
making a call to the selected application;
transmitting the text to the selected application; and
instructing the selected application to display the text.

18. The system of claim 10, further comprising a data storage unit for automatically storing the text as the input is received from the person.

19. A method for application-independent text entry, the method comprising:
receiving input comprising text provided by a person via at least one input means of a computing device;
displaying a user interface on the device, the user interface comprising the text and a plurality of icons, each icon associated with a different software application with which the text may be used;
detecting, by a text processing module executing on the device, a selection by the person of one of the applications; and
causing, by the text processing module, the selected application to communicate the text to another person or display the text in the selected application.

20. The method of claim 19, wherein the computing device comprises one of a mobile phone, a personal digital assistant (“PDA”), and a personal computer.

21. The method of claim 19, wherein the text processing module communicates the text to another person by:
making a call to the selected application;
transmitting the text to the selected application;
providing at least one recipient for the text to the selected application; and
instructing the selected application to communicate the text to the recipient.

22. The method of claim 19, further comprising:
determining whether the text comprises information identifying a recipient of the text;
in response to determining that the text comprises information identifying the recipient, determining whether the information is associated with at least one contact of the person;
in response to determining that the information is associated with at least one contact, presenting a selectable list comprising information identifying each contact; and
receiving a selection of at least one identified contact,
wherein the text processing module causes the selected application to communicate the text to each selected contact.

23. The method of claim 19, wherein the text processing module displays the text in the selected application by:
making a call to the selected application;
transmitting the text to the selected application; and
instructing the selected application to display the text.
